(19) United States
(12) Patent Application Publication
(10) Pub. No.: US 2011/0270671 A1
(43) Pub. Date: Nov. 3, 2011

(54) Predicting number of selections of advertisement using hierarchical Bayesian model

(76) Inventors: Hsiu-Kheurn Tang, San Jose, CA (US); Krishna Venkatraman, Palo Alto, CA (US); Lyle H. Ramshaw, Palo Alto, CA (US)

(21) Appl. No.: 12/772,576

(22) Filed: May 3, 2010

(51) Int. Cl. G06Q 30/00; G06F 9/44

(52) U.S. Cl. 705/14.41; 706/52

(57) ABSTRACT

A predetermined distribution type of a number of selections of an advertisement within a predetermined time period for a predetermined phrase and having a predetermined advertisement location is specified. A parameterization of a mean of the predetermined distribution type is also specified. The mean is determined using a hierarchical Bayesian model, based on the predetermined distribution type, the parameterization, and historical data regarding a number of actual selections of the advertisement for each of a number of phrases similar to the predetermined phrase. The mean corresponds to an average number of selections of the advertisement within the predetermined time period for the predetermined phrase and having the predetermined advertisement location, as predicted by the model.

### BACKGROUND

Internet search engines have proven popular among users as a way to locate desired information on the Internet. A user enters a phrase of one or more search terms on a web page of an Internet search engine. In response, the Internet search engine returns a list of web pages including these search terms.

Internet search engines can make money by displaying small advertisements with the list of web pages that include the search terms entered by the user. In general, advertisers can bid on particular search terms, and can indicate the maximum number of times their advertisements can be displayed with lists of web pages that include these search terms. The amount that an advertiser bids for a particular phrase typically controls where the advertiser's advertisement will be displayed with the list of web pages including the search terms of this phrase. For example, an advertisement having a higher bid is usually displayed higher on a web page than an advertisement having a lower bid.

### BRIEF DESCRIPTION OF THE DRAWINGS

FIG. 1 is a flowchart of a method for predicting a number of selections of an advertisement using a hierarchical Bayesian model, according to an embodiment of the present disclosure.

FIG. 2 is a diagram depicting representative historical data regarding the number of actual selections of an advertisement for each of a number of phrases, which is used by the hierarchical Bayesian model in the method of FIG. 1, according to an embodiment of the present disclosure.

FIG. 3 is a diagram depicting representative output of the hierarchical Bayesian model in the method of FIG. 1, according to an embodiment of the present disclosure.

FIG. 4 is a block diagram of a system for predicting a number of selections of an advertisement using a hierarchical Bayesian model, according to an embodiment of the present disclosure.

### DETAILED DESCRIPTION

As noted in the background section, advertisers can bid on particular search terms for their advertisements to be displayed with lists of web pages that include these search terms. An advertiser may associate an advertisement with a number of phrases of search terms. For example, an advertisement for installing a hot water heater may be associated with phrases such as “hot water,” “water heater,” “hot water heater,” “plumber,” and “emergency plumbing,” among other phrases. When a user searches for any of these phrases of search terms using an Internet search engine, the advertisement may be displayed with the list of web pages that include the search terms. If a user selects the advertisement, such as by clicking on the advertisement, the Internet search engine redirects the user to a web page of the advertiser that corresponds to the advertisement.

It has been found that the data regarding the number of times users select a given advertisement for various phrases of search terms is sparse data, and is said to have a long tail. The data is sparse in that for a large number of phrases of search terms, the number of selections is typically low, if not zero. The data is said to have a long tail in that the majority of selections of the advertisement are associated with a relatively small number of phrases of search terms, but that the number of selections of the advertisement that are associated with the majority of phrases of search terms is still a meaningful number.

An advertiser generally has a given advertising budget, and attempts to select bids for different phrases of search terms. The advertiser attempts to best utilize the advertising budget to maximize the number of times the advertisement is selected by users, after the advertisement has been displayed responsive to the users entering the phrases within a search engine. The number of selections for a given phrase of search terms is therefore useful in estimating how much the advertiser should bid on the phrase so that the advertisement is displayed when a user enters the phrase in a search engine.

In embodiments of the disclosure, a hierarchical Bayesian model is novelly used to predict the number of selections of an advertisement within a predetermined time period for a predetermined phrase, where the advertisement has a predetermined advertisement location. More specifically, a predetermined distribution type of this number of selections of the advertisement for the predetermined phrase is specified, such as a Poisson distribution. The mean of such a distribution corresponds to the average number of selections of the advertisement for the predetermined phrase in question.

As such, a hierarchical Bayesian model is novelly used to predict the mean of a distribution, such as a Poisson distribution, in embodiments of the disclosure, where this mean corresponds to the number of selections of an advertisement for a predetermined phrase. A hierarchical Bayesian model is hierarchical in that it models a random choice over two levels. In embodiments of the disclosure, the higher level of choice involves making a random choice from an assumed distribution for a particular phrase of search terms, where this choice may be influenced by the similarity of the particular phrase to other phrases. The lower level of choice then involves making a new random choice from a new distribution, influenced by the higher-level choice, to predict the number of selections of the advertisement that this particular phrase will generate.

By comparison, hierarchical Bayesian models have conventionally used binary logit models at their lower levels. A binary logit model is a logit model that analyzes binary data, where a given variable can take on one of just two different values. A logit model is a model that employs a logit, which is a type of mathematical function that is used in discrete choice and logistic regression analysis. That is, whereas embodiments of the disclosure employ a given type of distribution, such as a Poisson distribution, within the lower level of the hierarchical Bayesian model to determine a number of selections, conventional techniques use a binary logit model within the lower level to determine a binary output value (i.e., equal to one or zero) with a binary-logit probability.

For example, in the context of advertisers placing advertisements with Internet search engines, one type of binary logit model predicts whether a user who selects an advertisement is then likely to make a purchase on the web page to which the user is redirected. In this case, the data in question is binary: either a user does make a purchase, or does not make a purchase. Thus, while employing hierarchical Bayesian models to drive such types of binary logit models is commonplace, using a hierarchical Bayesian model to predict the mean of a distribution, such as a Poisson distribution, where the mean corresponds to the average number of selections of an advertisement for a predetermined phrase, is by comparison innovative.

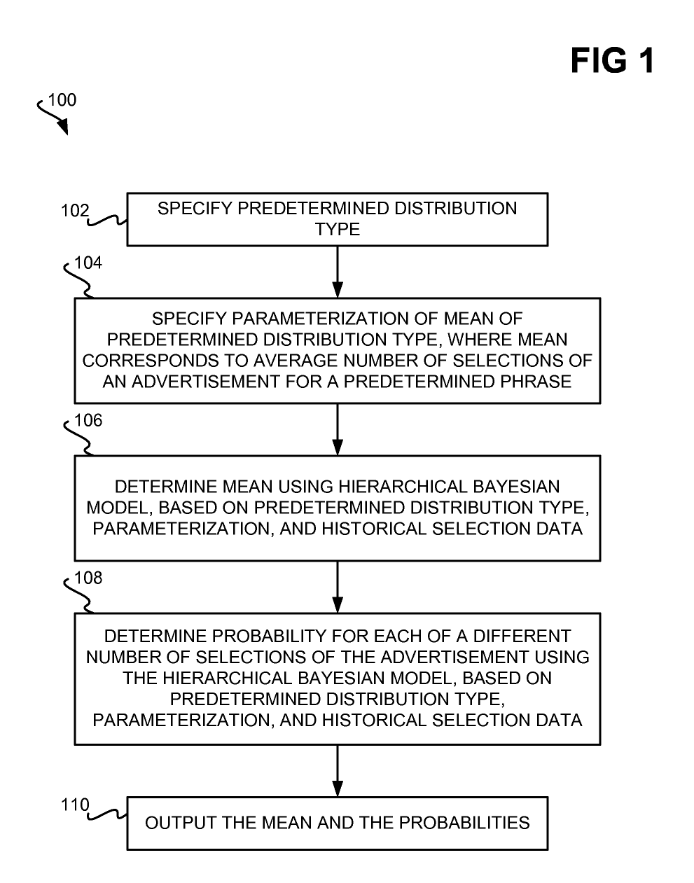

FIG. 1 shows a method 100, according to an embodiment of the disclosure. The method 100 may be implemented at least in part as one or more computer programs stored on a computer-readable data storage medium, such as a hard disk drive, a semiconductor memory, and so on. Execution of the computer programs by a computing device, such as by a processor of the computing device, results in the method 100 being performed.

The method 100 predicts a number of selections of an advertisement within a predetermined time period for a predetermined phrase, where the advertisement has a predetermined advertisement location. The predetermined phrase can be one or more search terms entered by a user at an Internet search engine, where the advertisement can be displayed with the search results for this phrase. The predetermined advertisement location can be a location on a web page of the Internet search engine that displays search results for the search terms. An advertisement can be considered as being selected when a user selects, such as by clicking, the advertisement as displayed on the web page such that the Internet search engine redirects the user to a different web page, which corresponds to the advertisement.

The predetermined time period may be a specific time period for any day of the week, for a particular day or days of the week, month or year, and so on. In one embodiment, the predetermined time period is any time period. The predetermined advertisement location may be the rank in which the advertisement is displayed on a web page of the Internet search engine as compared to other advertisements, such as the top-most advertisement displayed, the second-top-most advertisement displayed, and so on. In one embodiment, the predetermined advertisement location may be any location.

The method 100 as presented in relation to FIG. 1 presumes that a hierarchical Bayesian model having various free parameters has been postulated. Since the Bayesian model in question is hierarchical, the model involves making a sequence of random choices, where each choice is made from a specified distribution. Each distribution is controlled by various free parameters, so that there are free parameters within both the upper level and the lower level of the hierarchy. Once the structure of the hierarchical Bayesian model has been so determined, historical data may be used in accordance with a particular technique, such as a Markov Chain Monte Carlo technique, to determine which values of the free parameters will cause the resulting model to best fit the historical data. Thereafter, once the free parameters have been determined, the model is used to predict the number of times a particular search phrase will be selected.

A predetermined distribution type for the number of selections of the advertisement within the predetermined time period for the predetermined key phrase, where the advertisement has the predetermined advertisement location, is specified (102). In one embodiment, the predetermined distribution type is specified as a Poisson distribution. The Poisson distribution is a discrete probability distribution that expresses the probability of a number of events occurring in a fixed period of time if these events occur with a known average rate and independently of the time since the last event occurred.

The predetermined distribution type has a mean, which corresponds to the predicted average number of selections of the advertisement within the time period for the predetermined key phrase, where the advertisement has the predetermined advertisement location. The parameterization of the mean of the predetermined distribution type is specified (104). The parameterization of the mean mathematically characterizes the form of the mean using one or more constants.

In one embodiment, it has been determined that the following parameterization of the mean yields the most accurate predicted average number of selections of the advertisement within the time period for the predetermined key phrase, where the advertisement has the predetermined advertisement location:

$$τ \frac{{e}^{β}}{1 + {e}^{β}} .$$

In this parameterization, τ is a parameter that is identical for all phrases for the advertising campaign that includes the advertisement, including the predetermined phrase in relation to which the method 100 is being performed, and phrases that are similar to this predetermined phrase. By comparison, β is the output of the higher-level choice for the predetermined phrase. The mathematical constant e is the unique real number such that the value of the derivative of the function ƒ(x)=e^{x} at the point x=0 is equal to one.

The method 100 determines the mean using a hierarchical Bayesian model, based on the predetermined distribution type that has been specified in part 102, on the parameterization of the mean that has been specified in part 104, and on historical selection data (106). That is, the predetermined distribution type, the parameterization of the mean, and historical selection data are input into a hierarchical Bayesian model. In return, the hierarchical Bayesian model outputs the mean, which as noted above corresponds to the predicted average number of selections of the advertisement within the time period for the predetermined key phrase, where the advertisement has the predetermined advertisement location.

A hierarchical Bayesian model is generally defined as follows. Given data x and parameters v, a Bayesian analysis starts with a prior probability p(v) and the likelihood p(x|v) (i.e., the probability of x given v) to determine the posterior probability p(v|x)αp(x|v)p(v), which corresponds to the lower level of the model. The prior probability on v typically depends in turn on other parameters y, which corresponds to the higher level of the model. Therefore, the prior probability p(v) is replaced by the prior p(v|y), and the prior probability p(y) on the parameters y is introduced, resulting in the posterior probability p(v,y|x)αp(x|v)p(v|y)p(y).

In the specific context of embodiments of the disclosure, the higher level of the hierarchical Bayesian model selects the parameter β. By comparison, the lower level uses this parameter to determine a distribution of a particular type, such as a Poisson distribution, that results in selecting a number of selections per unit time. The formula

$$τ \frac{{e}^{β}}{1 + {e}^{β}}$$

is thus used in one embodiment to determine the Poisson distribution that constitutes the lower level of the hierarchical Bayesian model. In one embodiment, a Markov Chain Monte Carlo technique is employed to determine the free parameters of this hierarchical Bayesian model. This technique permits the best values to be determined for free parameters, such as τ, at both levels of the model. As such, the overall model optimally fits the historical data.

The formula

$$τ \frac{{e}^{β}}{1 + {e}^{β}}$$

describes how the lower level of the hierarchical Bayesian model uses the outputβ of the higher level to determine the mean of the assumed, lower-level Poisson (or other) distribution. By comparison, conventionally the outputβ from the higher level of the hierarchical Bayesian model is used within a binary logit model, or formula, within the lower level of the hierarchical Bayesian model, to generate a probability.

As has been described, a hierarchical Bayesian model includes a higher-level choice and a lower-level choice. In one embodiment, the choice made at the higher level of the hierarchical Bayesian model is the outputβ. Furthermore, in one embodiment, the choice made at the lower level of the hierarchical Bayesian model is the predicted number of selections of the advertisement, which is chosen from a Poisson distribution having the mean

$$τ \frac{{e}^{β}}{1 + {e}^{β}}$$

as noted above.

It is noted that the historical data is with regards to the number of actual selections of the advertisement for each of a number of phrases that are similar to the predetermined phrase in question. That two phrases are similar to one another can be defined in any desired manner. In one embodiment, a user determines that two phrases are similar to one another. For example, all the phrases with which a user has associated the advertisement may be considered as being similar to one another.

Another way by which phrases can be determined as being similar to one another is whether the phrases both include some form of the name of a company. For example, a hypothetical company Frobozz-Jork may also be commonly referred to as just Frobozz, or by the initials FJ. As such, phrases that include Frobozz-Jork, Frobozz, or FJ may be considered similar to one another. Other ways by which phrases can be determined as being similar to one another is whether the phrases both include names trademarked by a particular company, or if they both include model numbers of products made by this company. For example, if the hypothetical Frobozz-Jork has trademarked the terms Frobozz2000 and JorkAccelerator, then phrases that include either or both of these terms may be determined as being similar to one another.

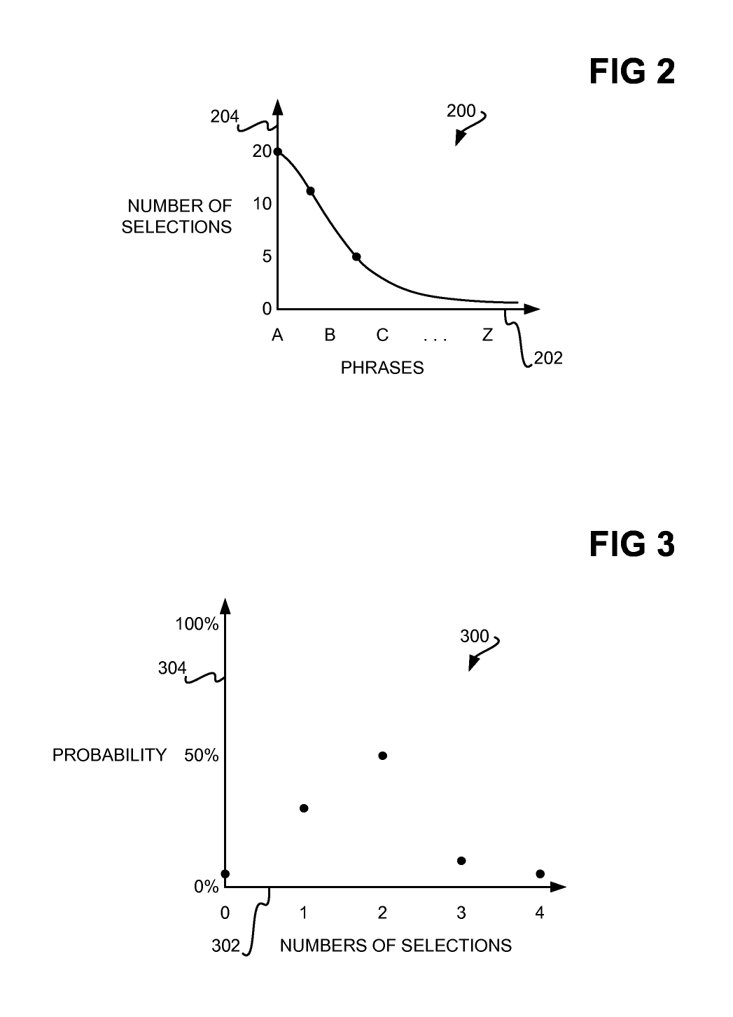

FIG. 2 shows representative historical data 200, according to an embodiment of the disclosure. The x-axis 202 denotes different phrases A, B, . . . , Z that are similar to the phrase in relation to which the method 100 is being performed. It is noted that there may be any number of such different phrases. The y-axis 204 denotes the number of actual selections of the advertisement in question that have been made when this advertisement is displayed in conjunction with search results for these different phrases. More generally, the y-axis 204 denotes the number of actual selections of the advertisement for these different phrases.

For example, consider an advertisement for installing a hot water heater. The phrase in relation to which the method 100 is being performed is “hot water heater.” The historical data specifies that for the phrase “water heater” users previously selected this advertisement twenty times, that for the phrase “hot water” users previously selected this advertisement thirteen times. By comparison, the historical data specifies that for the phrase “emergency plumber” users previously selected the advertisement in question five times, and for all other phrases, the historical data specifies that users previously selected this advertisement less than five times.

Assume that there are a total of twenty phrases. Therefore, for a relatively large number of phrases, few users selected the advertisement. That is, for most phrases, the number of selections is small, if not zero. As such, the historical data 200 is considered as being sparse. Assume also that in total, users clicked on the advertisement sixty times. Therefore, the first three phrases “water heater,” “hot water,” and “emergency plumber” account for thirty-eight of these sixty selections—i.e., a majority of the total number of selections. However, the remaining seventeen phrases still account for a non-negligible twenty-two selections. As such, the historical data 200 is said to have a long tail.

Referring back to FIG. 1, the method 100 can also use the hierarchical Bayesian model to determine the probability for each of a different number of selections of the advertisement, based on the predetermined distribution type that has been specified in part 102, on the parameterization of the mean that has been specified in part 104, and on the historical selection data (108). In effect, these probabilities are determined at the same time the mean is determined in part 106. This is because the mean is the average of all these different numbers of selections weighted by their probabilities.

FIG. 3 shows representative if rudimentary output 300 of the hierarchical Bayesian model in parts 104 and 106, according to an embodiment of the disclosure. The x-axis 302 denotes different numbers of selections of the advertisement, such as no (zero) selections, one selection, two selections, three selections, and four selections. The y-axis 304 denotes the probability that each such number of selections of the advertisement will likely occur.

For example, there is a 5% chance that no selections of the advertisement will occur for the phrase in question, there is a 30% chance that one selection of the advertisement will occur for this phrase, there is a 50% chance that two selections of the advertisement will occur, there is a 10% chance that three selections will occur, and there is a 5% chance that four selections will occur. Stated another way, there is a 50% chance that the total number of times that users will select the advertisement when the advertisement is displayed with search results for the phrase in question is two. Likewise, there is a 50% chance that total number of times that users will select the advertisement when the advertisement is displayed with search results for this phrase is other than two.

The predicted average number of times that users will select the advertisement for this phrase is the weighted average of all the numbers of times. Therefore, in the example of FIG. 3, this predicted average number of selections of the advertisement is 0×0.05+1×0.30+2×0.50+3×0.10+4×0.05, or 1.8 times. It is noted that this number corresponds to the mean of the predetermined distribution type, such as the Poisson distribution, of the number of selections of the advertisement for the phrase in question.

Referring back to FIG. 1, the method 100 outputs the mean of the predetermined distribution type, as well as the probabilities that have been determined (110). Such output may be achieved by displaying these values on a display device, storing the values on a computer-readable data storage medium, communicating the values over a network, and so on. Ultimately, the predicted number of selections of the advertisement for the phrase in question can be used as part of a process to determine how much to bid on this phrase for displaying the advertisement with the search results for this phrase.

The method 100 may thus be repeated for a number of different phrases, but for the same advertisement. In this way, an advertiser can accurately predict which phrases will result in the most selections of the advertisement when the advertisement is displayed with search results for these phrases. As such, the advertiser may decide how much—and indeed whether—to bid on the various phrases for displaying the advertisement with the search results for these phrases.

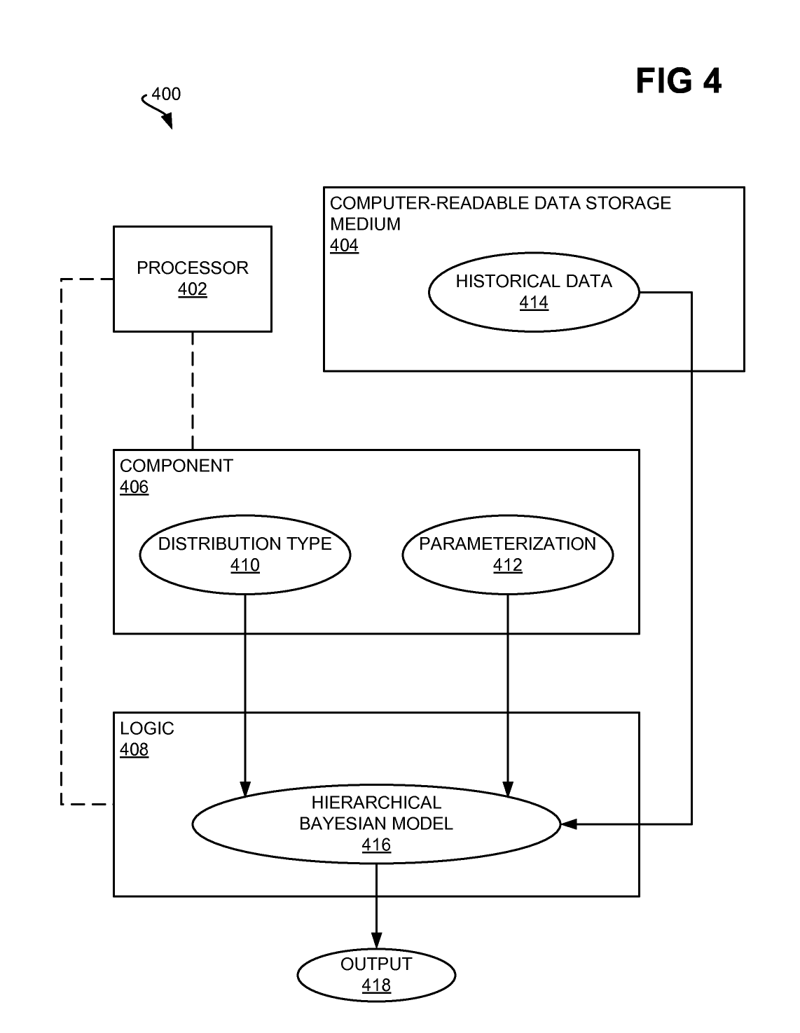

In conclusion, FIG. 4 shows a representative system 400, according to an embodiment of the disclosure. The system 400 includes a processor 402 and a computer-data storage readable medium 404. The system 400 may and typically does include other hardware, in addition to the processor 402 and the computer-readable data storage medium 404. The computer-readable data storage medium 404 may be or include a hard disk drive, semiconductor memory, and/or other types of computer-readable data storage media. The system 400 may be implemented as, over, or on one or more computing devices, such as desktop and laptop computers.

The system 400 includes a component 406 and logic 408, both of which are said to be implemented by the processor 402, which is indicated by dotted lines in FIG. 4. For example, the component 406 and the logic 408 may each be or include one or more computer programs. As such, the component 406 and the logic 408 are implemented by the processor 402, insofar as the processor 402 executes these computer programs to realize the respective functionality of the component 406 and the logic 408.

The component 406 specifies a distribution type 410 of a number of selections of an advertisement within a predetermined time period for a predetermined phrase, where the advertisement has a predetermined advertisement location. The component 406 also specifies the parameterization 412 of the mean of this distribution type. In this respect, the component 406 may request that the user provide input as to a desired distribution type 410 and a desired parameterization 412.

The logic 408 determines the mean of the distribution type 410 using a hierarchical Bayesian model 416, based on the distribution type 410 and the parameterization 412 of the mean of the distribution type 410, as well as based on historical data 414 stored on the computer-readable data storage medium 404. The historical data 414 is with regards to a number of actual selections of the advertisement in question for each of a number of different phrases that is similar to the predetermined phrase. Stated another way, the distribution type 410 and the parameterization 412 are input into the hierarchical Bayesian model 416, such that output 418 is generated by the model 416.

The output 418 includes the mean of the distribution type 410, which corresponds to an average number of selections of the advertisement within the predetermined time period for the predetermined phrase, where the advertisement has the predetermined advertisement location, as predicted by the hierarchical Bayesian model 416. The output 416 can also include the probability for each of a different number of selections of the advertisement within the predetermined time period for the predetermined phrase, where the advertisement has the predetermined advertisement location. This latter type of output 418 is also determined by the logic 408 using the hierarchical Bayesian model 416. In these respects, the logic 408, as well as the component 406, can thus be said to perform the method 100 that has been described.

We claim:

1. A method comprising:
specifying a predetermined distribution type of a number of selections of an advertisement within a predetermined time period for a predetermined phrase and having a predetermined advertisement location;
specifying a parameterization of a mean of the predetermined distribution type; and,
determining the mean by a computing device using a hierarchical Bayesian model, based on the predetermined distribution type, the parameterization, and historical data regarding a number of actual selections of the advertisement for each of a plurality of phrases similar to the predetermined phrase,
wherein the mean corresponds to an average number of selections of the advertisement within the predetermined time period for the predetermined phrase and having the predetermined advertisement location, as predicted by the model.

2. The method of claim 1, further comprising outputting the mean by the computing device.

3. The method of claim 1, further comprising determining a probability for each of a different number of selections of the advertisement within the predetermined time period for the predetermined phrase and having the predetermined advertisement location, by the computing device using the model.

4. The method of claim 1, wherein the predetermined distribution type is specified as a Poisson distribution.

5. The method of claim 1, wherein the predetermined phrase includes one or more search terms entered within an Internet search engine, the predetermined advertisement location is a location on a web page of the Internet search engine that displays search results for the search terms, and each selection of the advertisement corresponds to a user selecting the advertisement as displayed on the web page such that the Internet search engine redirects the user to a different web page that corresponds to the advertisement.

6. The method of claim 1, wherein the parameterization of the mean is specified as
$$τ \frac{{e}^{β}}{1 + {e}^{β}} ,$$
where τ is a parameter that is identical for all phrases for an advertising campaign including the advertisement, including the predetermined phrase and the plurality of phrases similar to the predetermined phrase, and wherein β is an output of a higher-level choice within the hierarchical Bayesian model.

7. The method of claim 1, wherein the historical data regarding the number of actual selections of the advertisement for each of the plurality of phrases similar to the predetermined phrase is sparse data having a long tail.

8. The method of claim 1, wherein the model is not used by the computing device to drive a binary logit model.

9. A system comprising:
a processor;
a computer-readable data storage medium to store historical data regarding a number of actual selections of an advertisement for each of a plurality of phrases similar to a predetermined phrase;
a component implemented by at least the processor to specify a predetermined distribution type of a number of selections of the advertisement within a predetermined time period for the predetermined phrase and having a predetermined advertisement location, and to specify a parameterization of a mean of the predetermined distribution type; and,
logic implemented by at least the processor to determine the mean using a hierarchical Bayesian model, based on the predetermined distribution type, the parameterization, and the historical data,
wherein the mean corresponds to an average number of selections of the advertisement within the predetermined time period for the predetermined phrase and having the predetermined advertisement location, as predicted by the model.

10. The system of claim 9, wherein the logic is further to determine a probability for each of a different number of selections of the advertisement within the predetermined time period for the predetermined phrase and having the predetermined advertisement location, using the model.

11. The system of claim 9, wherein the predetermined distribution type is specified as a Poisson distribution, and the parameterization of the mean is specified as
$$τ \frac{{e}^{β}}{1 + {e}^{β}} ,$$
where τ is a parameter that is identical for all phrases for an advertising campaign including the advertisement, including the predetermined phrase and the plurality of phrases similar to the predetermined phrase, and wherein β is an output of a higher-level choice within the hierarchical Bayesian model.

12. The system of claim 9, wherein the predetermined phrase includes one or more search terms entered within an Internet search engine, the predetermined advertisement location is a location on a web page of the Internet search engine that displays search results for the search terms, and each selection of the advertisement corresponds to a user selecting the advertisement as displayed on the web page such that the Internet search engine redirects the user to a different web page that corresponds to the advertisement.

13. The system of claim 9, wherein the historical data regarding the number of actual selections of the advertisement for each of the plurality of phrases similar to the predetermined phrase is sparse data having a long tail.

14. A computer-readable data storage medium having a computer program stored thereon, execution of the computer program by a computing device causing a method to be performed, the method comprising:
specifying a predetermined distribution type of a number of selections of an advertisement within a predetermined time period for a predetermined phrase and having a predetermined advertisement location;
specifying a parameterization of a mean of the predetermined distribution type; and,
determining the mean by a computing device using a hierarchical Bayesian model, based on the predetermined distribution type, the parameterization, and historical data regarding a number of actual selections of the advertisement for each of a plurality of phrases similar to the predetermined phrase,
wherein the mean corresponds to an average number of selections of the advertisement within the predetermined time period for the predetermined phrase and having the predetermined advertisement location, as predicted by the model.

15. The computer-readable data storage medium of claim 14, wherein the predetermined distribution type is specified as a Poisson distribution, and the parameterization of the mean is specified as
$$τ \frac{{e}^{β}}{1 + {e}^{β}} ,$$
where τ is a parameter that is identical for all phrases for an advertising campaign including the advertisement, including the predetermined phrase and the plurality of phrases similar to the predetermined phrase, and wherein β is an output of a higher-level choice within the hierarchical Bayesian model.
